(19) United States
(12) Patent Application Publication
(10) Pub. No.: US 2003/0118626 A1
(43) Pub. Date: Jun. 26, 2003

(54) Stable pesticidal chemical formulations

(76) Inventors: John Kibbee, Guelph (CA); Gao Sun, Guelph (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/247,481

(22) Filed: Sep. 20, 2002

Related U.S. Application Data
(60) Provisional application No. 60/323,719, filed on Sep. 21, 2001.

(51) Int. Cl. A01N 25/12; A01N 25/00; A01N 25/26; A01N 25/28

(52) U.S. Cl. 424/417; 504/367

(57) ABSTRACT

The present invention provides pesticidal chemical flowable compositions comprising one or more active ingredients, and other dispersed ingredients, dispersed in an aqueous continuous phase, and an amount of low-density particles sufficient to substantially reduce the difference between the density of the continuous phase and the average density of the dispersed ingredients, inclusive of the low-density particles. The invention also extends to the methods of using low-density particles to inhibit phase separation in pesticidal chemical flowables.

### FIELD OF THE INVENTION

The present invention is in the field of formulations for chemical flowables. In particular, the invention relates to formulations for inhibiting phase separation in water-based pesticidal dispersions, including low to medium viscosity flowables.

### BACKGROUND OF THE INVENTION

Flowables are suspensions or dispersions of water insoluble pesticide(s) and possibly other components in liquid (usually aqueous) media. Such products are typically concentrates that are diluted with water for spraying for control of pests, or are used as seed treatments with or without dilution.

A fundamental problem with flowables is that during storage, the dispersed ingredients tend to settle. Typically, the particles are heavier than the liquid medium in which they are dispersed and settle to the bottom of the container. In some cases, the particles may be lighter than the liquid medium and may tend to float. Regardless, the settling of the product is undesirable, making the product non-uniform and often resulting in sediments that are difficult to reconstitute. Failure to reconstitute such sediments may result in inaccurate pesticide application or plugging of strainers or spray nozzles, among other things.

Two basic approaches have been used to prevent or minimize such settling. One approach is to add thickeners, suspending agents or rheological modifiers to the flowables. This often provides significant improvement, but sediments may still develop on long term storage. Also, such additives significantly increase the viscosity of the product which is undesirable from a production and handling perspective, particularly for seed treatment flowables that are used without dilution.

A second approach is to design the product so that the density of the liquid medium is the same as the average density of the dispersed ingredients. Several alternatives are available. One method is to increase the density of the liquid medium, but this has limited applicability as most pesticides are more dense than can reasonably be achieved by adding solutes to water. Oil may also be added as a bouyant, so that the average density of the oil plus other dispersed ingredients is the same as the liquid medium. While this works for some formulations within limited ranges of concentrations and ingredient densities, often it is not feasible. For example, the concentration of active ingredient is often limited to relatively dilute systems (usually less than about 15% active ingredient) because the density of the oil is not low enough to buoy up a large amount of solids. Normally, the addition of oil is also not effective for very dilute flowables (with less than about 5% active ingredient) due to the low solids content. In these cases, phase separation still occurs, where the solids will settle if the density of the dispersed phase is slightly higher than the liquid medium and float if the density of the dispersed phase is slightly lower than the liquid medium. Also, when using oil, the oil may absorb onto the particle surfaces non-uniformly, making some of the particles lighter than the liquid medium and some heavier than the liquid medium. In such cases, phase separation may occur where a portion of the solids settle, a portion of the solids float, and a middle bleed layer forms.

Various other mechanisms have been developed for preventing phase separation, particularly in dilute flowables, such as is described in U.S. Pat. No. 6,074,987. This patent describes the use of hydrophobic fumed silica to reduce phase separation. While this approach reduces the rate or amount of phase separation, based on the data in the patent, a significant amount will still occur.

### SUMMARY OF THE INVENTION

It has been found that the addition of low-density particles, such as hollow glass microspheres and micronized polyethylene, to pesticidal chemical flowables inhibits phase separation. The amount of low-density particles used should be sufficient to substantially reduce the difference between the density of the continuous phase and the average density of the dispersed ingredients (dispersed phase), inclusive of the low-density particles.

The present invention therefore provides a pesticidal chemical flowable composition comprising dispersed ingredients, said dispersed ingredients comprising one or more active ingredients, dispersed in a continuous phase, and an amount of low-density particles sufficient to substantially reduce the difference between the density of the continuous phase and the average density of the dispersed ingredients, inclusive of the low-density particles. In an embodiment of the invention, the amount of low-density particles is in the range of about 0.5% to about 25%.

In specific embodiments of the present invention there is provided an pesticidal chemical flowable composition comprising:

about 0.02% to about 50% of one or more active ingredients,

about 0.5% to about 25% of low-density particles,

about 0.1% to about 5% of one or more dispersants, wetting agents and/or emulsifiers,

about 0.02% to about 3% of one or more thickeners,

about 1% to about 35% of one or more antifreeze compounds,

about 20-80% of water, and;

optionally, one or more ingredients selected from the group consisting of defoamers, antimicrobial agent(s), dyes, pigments, oils, polymers, fillers and other additives commonly used in pesticidal formulations;

wherein the amount of low-density particles is sufficient to substantially reduce the difference between the density of the continuous phase and the average density of dispersed ingredients, inclusive of the low-density particles.

In an embodiment of the invention the low-density particles are hollow glass microspheres or micronized polyethylene.

In another embodiment of the present invention, there is provided an pesticidal chemical flowable composition comprising:

dispersed ingredients comprising one or more active ingredients and fine particles, dispersed in a continuous phase;

an amount of low-density particles sufficient to substantially reduce the difference between the density of the continuous phase and the average density of the dispersed ingredients, inclusive of the low-density particles;

wherein the fine particles are present in an amount sufficient to provide a ratio of fine particles to low-density particles in the range of about 0.1 to about 8.0, preferably about 0.2 to about 6.

In further embodiments of the present invention, the fine particles are selected from the group consisting of calcium carbonate, clays, titanium dioxide, silica, talc, silicates, and pigments.

The present invention further involves a use of low-density particles to inhibit phase separation in pesticidal chemical flowables.

There is also provided a method of inhibiting phase separation in pesticidal chemical flowables comprising adding low-density particles to the composition in amounts sufficient to substantially reduce the difference between the density of the continuous phase and the average density of the dispersed ingredients, inclusive of the low-density particles.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE INVENTION

It has been found that phase separation in low-density pesticidal flowables can be inhibited by the addition of low-density particles, for example hollow glass microspheres or micronized polyethylene, provided that the amount of low-density particles added to the composition is sufficient to substantially reduce the difference between the density of the continuous phase and the average density of the dispersed ingredients, inclusive of the low-density particles.

The present invention therefore provides a pesticidal chemical flowable composition comprising dispersed ingredients, said dispersed ingredients comprising one or more active ingredients, dispersed in a continuous phase, and an amount of low-density particles sufficient to substantially reduce the difference between the density of the continuous phase and the average density of the dispersed ingredients, inclusive of the low-density particles. In an embodiment of the invention, the amount of low-density particles is in the range of about 0.5% to about 25%.

As used herein, the term “flowable” refers to a pesticidal chemical dispersion, typically a water-based dispersion. The pesticidal chemical flowable compositions of the invention consist of dispersed ingredients (dispersed phase) and a continuous phase. The dispersed ingredients include any ingredient found as discrete particles or droplets in the flowable and normally include, for example, the active ingredient(s), oil, clays, pigments and any other water-insoluble component. The continuous phase is the water and water-soluble components in the flowable. The dispersed ingredients are dispersed or emulsified in the continuous phase. Low-density particles are able to reduce the rate of or prevent phase separation in pesticidal chemical flowables having a viscosity as low as 40 centipoise.

The compositions of the present invention therefore include one or more active ingredients; the low-density particles; one or more wetting agents, dispersants and/or emulsifiers; one or more thickeners; one or more antifreeze compounds; water; and other optional ingredients typically found in pesticidal chemical flowables.

The amount of low-density particles added to the formulation should be sufficient to substantially reduce the difference between (or equalize) the density of the continuous phase and the average density of the dispersed ingredients (dispersed phase), inclusive of the low-density particles. Other ingredients typically found in pesticidal chemical flowables include, but are not limited to, antimicrobial agent(s), dyes, pigments, fillers, oils and polymers.

Therefore, in embodiments, the present invention provides an pesticidal chemical flowable composition comprising:

about 0.02% to about 50% of one or more active ingredients,

about 0.5% to about 25% of low-density particles,

about 0.1% to about 5% of one or more dispersants, wetting agents and/or emulsifiers,

about 0.02% to about 3% of one or more thickeners,

about 1% to about 35% of one or more antifreeze compounds,

about 20-80% of water,and

optionally, one or more ingredients selected from the group consisting of defoamers, antimicrobial agent(s), dyes, pigments, fillers, oils, polymers and other common additives used in pesticidal formulations.

wherein the amount of low-density particles is sufficient to substantially reduce the difference between the density of the continuous phase and the average density of the dispersed ingredients, inclusive of the low-density particles.

In embodiments of the invention, the amount of low-density particles is sufficient to substantially equalize the density of the continuous phase and the average density of the dispersed ingredients, inclusive of the low-density particles.

By an amount “sufficient to substantially reduce the difference between the density of the continuous phase and the average density of the dispersed ingredients, inclusive of the low-density particles” it is meant an amount of low-density particles that provides a difference in the average density of the dispersed ingredients, inclusive of the low-density particles, and the continuous phase in the range of about −0.20 g/ml to about +0.20 g/ml, suitably about −0.10 g/ml to about +0.10 g/ml.

Unless otherwise stated, all percentages used herein are expressed as a percent by weight (wt/wt) of the final product.

Low-Density Particles

The low-density particles may be any particle that is made of a low density material such as certain polymers, or that encapsulates air, such as hollow microparticles. The following are the characteristics of low-density particles that are useful for the present invention:

1. Impermeable to water.

2. Density in the range of about 0.3 g/ml to about 1.3 g/ml, preferably about 0.4 g/ml to about 1.05 g/ml.

3. Particle size in the range of about 0.5 μm to about 100 μm, preferably about 1 μm to about 50 μm.

4. Composed of materials selected from the group consisting of glass, specifically borosilicate glass (soda lime), silicates, ceramic, perlite, oxidized polyethylene and polyethylene.

In an embodiment of the present invention, the low-density particles for inclusion in the compositions of the invention are hollow glass microspheres, specifically Scotchlite™ K46 and Scotchlite™ S60. In another embodiment of the present invention, the low-density particles are polyethylene microparticles, such as micronized polyethylene, specifically Acumist B6™.

Hollow glass microspheres (Scotchlite brand) and ceramic microspheres are available from, for example, 3M (St. Paul, Minn). Perlite may be obtained, for example, from American Stone Pioneers (Rolling Hills Estates, Calif) and polyethylene and oxidized polyethylene microspheres may be obtained, for example, from Honeywell International (Morristown, N.J.). Micronized polyethylene is available from Honeywell, Morristown, N.J.

One of the features of the present invention is that the amount of the low-density particles added to the aqueous liquid suspension (i.e. the flowable) is such that the average density of the dispersed ingredients (i.e. the total weight of the dispersed ingredients divided by the total volume of the dispersed ingredients), including the low-density particles, is the same as or not greatly different than the density of the continuous phase. What this means, in practical terms, is that the density of the entire composition, after addition of the low-density particles, is approximately the same, or the same as the density of the continuous phase alone, and also the average density of the dispersed ingredients (dispersed phase) alone.Therefore, the amount of low-density particles to be added will depend on the density of the low-density particles, the density of the continuous phase alone and the amount and density of the other dispersed ingredients. The lower the density of the continuous phase, the greater the amount of low-density particles required. Similarly, the greater the density and amount of other components in the dispersed phase, the more low-density particles would be required to density balance the formulation. Also, for any particular starting liquid dispersion the amount (weight) required of the low-density particles will increase as the density of the low-density particles increases. Conversely, a smaller amount (weight) of the low-density particles will be required to effect a given reduction in density of the final composition as density of the low-density particles decreases.

There are several methods of determining the amount of low-density particles that are required to make the average density of the dispersed ingredients and the density of the continuous phase substantially equivalent, including both experimental and mathematical methods.

One experimental method of determining the amount of low-density particles to add to the composition would be to prepare a sample of the continuous phase, and then measure the density. A series of samples using this continuous phase may be prepared with varying amounts of low-density particles, and the densities of these samples may be measured. When the correct amount of low-density particles are included, the density of the complete formulation will be substantially the same as the density of the continuous phase, and the formulation would be density balanced.

Mathematically, calculation of the amount of low-density particles required for density balancing (i.e. substantially equalizing the average density of the dispersed ingredients and the continuous phase) is based on conservation of volume on mixing. This calculation is used to determine the amount of low-density particles required to make the total weight of dispersed ingredients divided by the total volume of the dispersed ingredients equal to the density of the continuous phase, by satisfying the conditions for the following equation to be true:

$${d}_{CP} = \frac{{W}_{LDP} + \sum {W}_{DPi}}{{W}_{LDP} / {d}_{LDP} + \sum ( {W}_{DPi} / {d}_{DPi} )}$$

where:

d_{CP} is the known density of the continuous phase

W_{LDP} is the weight of low-density particles to be included

d_{LDP} is the known density of the low-density particles

W_{DPI} are the known weights of the other individual ingredients of the dispersed phase

d_{DPI,} are the known densities of the other individual ingredients of the dispersed phase

W_{LDP} can be determined either by successive approximation, varying W_{LDP} until the equation is essentially satisfied, or rearranging the equation as follows to determine the amount of low-density particles required:

$${W}_{LDP} = \frac{\sum {W}_{DPi} - {d}_{CP} \sum ( {W}_{DPi} / {d}_{DPi} )}{( {d}_{CP} / {d}_{LDP} - 1 )}$$

Generally the mathematical method described above is reasonably accurate if good data on ingredient density is available and volume on mixing is conserved. However, it should be noted that in some cases the optimum amount of low-density particles to add for best formulation stability is slightly different than that which is calculated above. Typically, the optimum amount of low-density particles required will be within 1% (i.e. the optimum W_{LPD} is the calculated W_{LDP}+/−1%). For this reason, the optimum amount of low-density particles may be verified experimentally.

Although it is preferred to make the continuous phase density (d_{CP}) and dispersed phase density (d_{DP}) substantially equal to each other, to obtain the highest degree of stability, small differences in the densities, for example Δd=d_{CP}−d_{DP}=±0.2 g/ml, especially Δd=±0.1 g/ml, will still give acceptable stability in most cases, generally manifested by absence of phase separation, e.g. little or no appearance of a clear liquid phase for at least 3 months or more at 20-25° C. or for at least 1 month at 50° C. Products formulated with continuous/dispersed phase density differences greater than the above may provide slower rates of phase separation, but not the full advantages of the invention, and are within the scope of the present invention.

Generally, the amount of low-density particles required to equalize dispersed phase density and continuous phase density will be within the range of from about 0.5% to about 25% by weight, suitably about 1% to about 20% by weight of the composition.

Fillers

The presence of fillers, particularly insoluble particles of fine particle size, in the compositions of the present invention may contribute to the inhibition of phase separation provided by the low-density particles. A fine particle size is defined as an average particle size of approximately less than 5 μm, and preferably less than 3 μm. Examples of the fine particles that have been shown to be beneficial include, but are not limited to, calcium carbonate, clays and pigments. Particularly preferred ratios of the amounts of fine particles:low-density particles are in the range of about 0.1 to about 8.0, suitably about 0.2 to about 6. If clays (as a suspending agent) and/or pigments (for colour) are used in the pesticidal chemical flowable then the requirement for the presence of fine particles may be satisfied. If the flowable does not require the presence of one of these ingredients, or another ingredient that may be classified as a fine particle, then it may be beneficial to add materials specifically for this purpose.

In an embodiment of the present invention, there is therefore provided a pesticidal chemical flowable composition comprising:

dispersed ingredients comprising one or more active ingredients and fine particles, dispersed in a continuous phase;

an amount of low-density particles sufficient to substantially reduce the difference between the density of the continuous phase and the average density of the dispersed ingredients, inclusive of the low-density particles;

wherein the fine particles are present in an amount sufficient to provide a ratio of fine particles to low-density particles in the range of about 0.1 to about 8.0, preferably about 0.2 to about 6.

In further embodiments, the fine particles are selected from the group consisting of calcium carbonate, clays, titanium dioxide, silica, silicates, talc, and pigments.

In more specific embodiments, the present invention provides a pesticidal chemical flowable composition comprising:

about 0.02% to about 50% of one or more active ingredients,

about 0.5% to about 25% of low-density particles,

about 0.2% to about 20% of one or more fine particulate materials,

about 0.1% to about 7% of one or more dispersants, wetting agents and/or emulsifiers.

about 0.02% to about 3% of one or more thickeners,

about 1% to about 35% of one or more antifreeze compounds,

about 20-80% of water, and

optionally, one or more ingredients selected from the group consisting of defoamers, antimicrobial agent(s), dyes, pigments, fillers, oils, polymers and other common additives used in pesticidal formulations;

wherein the amount of low-density particles is sufficient to substantially reduce the difference between the density of the continuous phase and the average density of the dispersed ingredients, inclusive of the low-density particles.

In an embodiment of the invention, the amount of low-density particles is sufficient to substantially equalize the density of the continuous phase and the average density of the dispersed ingredients, inclusive of the low-density particles.

Active Ingredients

The one or more active ingredients may be any pesticidal chemical that is suitable for inclusion in flowable products. This includes a variety of types of applications including herbicides, insecticides, fungicides and growth regulants. Such chemicals may be used in any pesticidal product, including household, agricultural, and recreational. In embodiments of the invention, the active ingredient is a pesticide useful in seed-treatment formulations and may be selected from the group consisting of insecticides, fungicides and mixtures thereof. For example, suitable compounds include but are not limited to, azoxystrobin, captan, carbathiin, clothianidin, difenaconazole, fludioxonil, imidacloprid, ipconazole, lindane, metalaxyl, permethrin, tebuconazole, thiabendazole, thiamethoxam, thiram, triadimenol, trifloxystrobin, tritaconazole, and mixtures thereof. The amount of active ingredient in the composition may be in the range of about 0.02% to about 50%, suitably about 0.1% to about 40%. The amount of active ingredient may vary depending on the application, and may fall outside of the above ranges, A person skilled in the art would know how to select the amount of active ingredient depending on the desired application.

In embodiments of the present invention the one or more active ingredients includes a pesticide that is soluble in the continuous phase in addition to a pesticide that is not soluble in the continuous phase.

Wetting Agents, Dispersants and Emulsifiers

Wetting agents, dispersants and/or emulsifiers are well known ingredients used in pesticidal chemical flowables.

Wetting agents serve to reduce the surface tension at the water-solid interface and therefore, increase the tendency of the water to contact the complete surface of the active ingredient particles. Most active ingredients used in pesticidal chemical flowables are hydrophobic and therefore do not mix well with water. A wetting agent assists in mixing the pesticide into the water. Dispersants are surfactants that absorb onto the surface of the dispersed ingredients to help stabilize the dispersion. They are used to reduce and stabilize the viscosity of the suspension, and help to prevent flocculation of particles. Emulsifiers assist in emulsification of any water insoluble liquid components that are included in the formulations.

These dispersants, wetting agents and emulsifiers are commonly anionic and nonionic surfactants and more than one surfactant may be used. Examples of anionic surfactants include, but are not limited to, alkyl polyether alcohol sulfates, arylalkyl polyether alcohol sulfates, arylalkyl sulfonates, alkylnaphthalene sulfonates, and alkyl phenoxybenzene disulfonates. Nonionic surfactants include, but are not limited to, arylalkyl polyether alcohols, alkyl polyether alcohols, polyoxyethylene fatty acid esters, polyethylene sorbitan fatty acid esters, polyalkylene oxide block copolymers, polyalkylene oxide block copolymer monohydric alcohols and polyalkylene oxide block copolymer alkyl phenols. Other dispersants include, but are not limited to sodium lignosulfonate, salts of carboxylated polyelectrolytes, sodium hexametaphosphate, and tetrasodium pyrophosphate.

Preferred compounds for these functions are dependent on the type(s) of active ingredient and other dispersed ingredients in the formulation and other factors not specifically related to the invention, but ethoxylated polyoxypropylene and sodium lignosulfonate are often effective. A person skilled in the art would be able to determine the best compounds to use as wetting agents, dispersants and/or emulsifiers.

Thickeners

Thickeners (sometimes referred to as suspending agents) help to prevent settling of the product by increasing the viscosity of the product through other mechanisms, and the benefits and use of such thickeners are well know in the art. Examples of thickeners include, but are not limited to, polysaccharide gums such as xanthan gum, guar gum and gum arabic; cellulose ethers; organically modified montmorillonite clays; attapulgite clays; smectite clays; acrylics; acrylic co-polymers; and carboxy-vinyl copolymers. In an embodiment of the invention, the thickeners include xanthan gum and attapulgite clay or combinations thereof. The total amount of thickener may be in the range of about 0.01% to about 4%, suitably about 0.02% to about 3%.

Antifreeze Agents

An anti-freeze agent (freezing point depressant) includes, but is not limited to, relatively low molecular weight aliphatic alcohols such as ethylene glycol, propylene glycol, glycerine, hexane diol, and sorbitol and mixtures thereof and compounds such as urea. In an embodiment of the invention, the anti-freeze agents include ethylene glycol, dipropylene glycol, urea, glycerine, and propylene glycol. The amount of antifreeze may be in the range of about 1% to about 40%, suitably about 5% to about 30%. Antifreeze is needed if the pesticidal chemical flowable is to be used at low temperatures, and to improve the freeze/thaw stability of the product.

Oil

Oil has previously been used as an additive in pesticidal flowables to produce density balanced formulations. Oils may include, but are not limited to, petroleum hydrocarbon distillates such as mineral oils, or vegetable oils such as canola, soy or corn oils. The amount of oil to add to achieve a density balanced condition would be determined in a manner similar to that described for the low-density particles. Due to its relatively high density and other factors, oil has significant limitations in comparison to the low-density particles described herein, but can be used as a buoyant in combination with the low-density particles to achieve a density balanced condition. When oil is included in the formulation, for the purpose of calculation of the amount of low-density particles to include for density balancing, the oil should treated as one of the dispersed phase ingredients. If included, the amount of oil may be in the range of about 1% to about 20%, suitably about 4% to about 15%.

Other Optional Ingredients

Other ingredients typically used in pesticidal chemical flowables may be included in the composition. Examples include, but are not limited to, defoamers, preservatives or biocides, dyes or pigments, oil, pH adjusters, stickers, and polymers.

Defoamers are compounds that are added to flowables to control foaming due to the presence of surfactants, such as wetting agents or dispersants. Defoamers typically include hydrophobic silica compounds and may be present in amounts ranging from about 0.003% to about 0.3%.

Some surfactants and thickeners are prone to bacterial decomposition. In some cases preservatives and/or biocides are added to prevent this. Examples of preservatives and biocides used to prevent the growth of bacteria, fungi, or other microbial organisms that can flourish in an aqueous environment include, but are not limited to, 1,2-benzisothiazolin-3-one, methyl or propyl parahydroxybenzoate, 2-bromo-2-nitro-propane-1,2-diol, sodium benzoate, glutaraldehyde, O-phenylphenol, 5-chloro-2-methyl-4-isothiazolin-3-one, pentachlorophenol, 2,4-dichloro-benzyl alcohol, and benzisothiazolinones. Preferred antimicrobial agents include 1,2-benzisothiazolin-3-one, 2-methyl-4-isothiazolin-3-one plus, 5-chloro-2-methyl-4-isothiazolin-3-one. Preservatives and biocides are generally used at level of around 0.2%.

Dyes or pigments may be used in seed treatment formulations to indicate that seeds have been treated. Treated seeds must be conspicuously coloured to prevent the inadvertent consumption by people or animals, and may be included in the product or added at the time of use. Pigments and dyes may be used at levels of around 0.2% to about 6%, as required to provide the required colouration to the seed.

pH adjusters or buffers may be added to adjust the formulation pH. Stickers or polymers may be added to improve adhesion of the formulation to seeds or to the target crop.

Methods of the Invention

By adding low-density particles to pesticidal chemical flowables in amounts sufficient to substantially equalize the density of the continuous phase and the average density of the dispersed ingredients, inclusive of the low-density particles, separation of the solid and liquid phases, or the development of a “bleed layer”, is inhibited. Bleed layer (or syneresis) is the measure of phase separation. The bleed layer may form on the top, middle or bottom of the sample after storage. The term “inhibiting phase separation” as used herein means a reduction in the amount of phase separation (or bleed layer) in a pesticidal chemical flowable composition compared to a control composition. A control composition is a composition having the same ingredients, except the low-density particles have been replaced with the same amount of an alternate solid material, or replaced with additional continuous phase components, or replaced with other components in the formulation.

The present invention therefore extends to methods of inhibiting phase separation in pesticidal chemical flowable compositions comprising adding low-density particles to the composition in amounts sufficient to substantially reduce the difference between the density of the continuous phase and the average density of the dispersed ingredients, inclusive of the low-density particles.

In a further embodiment of the present invention, the addition of fine particles, including, but not limited to, calcium carbonate, clays, titanium dioxide, silica, silicates, talc, and pigments, improves the ability of the low-density particles to inhibit phase separation in pesticidal chemical flowables. The present invention therefore extends to methods of inhibiting phase separation in pesticidal chemical flowable compositions comprising:

adding low-density particles to the composition in amounts sufficient to substantially reduce the difference between the density of the continuous phase and the average density of the dispersed ingredients, inclusive of the low-density particles; and

adding fine particles to the composition in amounts sufficient to provide a ratio of fine particles to low-density particles in the range of about 0.1 to about 8.0, preferably 0.2 to about 6.0.

The low density particles may be added to the flowable composition at any time, with the exception of low density particles, such as hollow glass microspheres, which may be damaged during grinding (if required) of the flowable. Such particles may be added to the flowable after grinding (if required).

The present invention also extends to the use of low-density particles, to inhibit phase separation in pesticidal chemical flowables. Low-density particles are able to reduce phase separation in pesticidal chemical flowables having a viscosity as low as 40 centipoise.

The following non-limiting examples are illustrative of the present invention:

### EXAMPLES

Preparation Method

In general, the flowables were prepared as is typical for water based pesticidale flowables, other than the requirement for incorporating hollow spheres. Hollow spheres may not be ground with the rest of the formulation since grinding will break the spheres so that air would no longer be encapsulated and the flotation properties of the spheres would be reduced or lost. All ingredients except the hollow glass spheres were mixed and then ground in an appropriate mill. The hollow glass spheres were added with low to medium shear agitation to the ground product. Specifically, lab samples were prepared as follows: The ingredients were added in the order listed for the specific formulations, while mixing with a propeller agitator. Typically, liquid ingredients were added first, followed by solid (normally powdered) ingredients. The slurry was mixed until uniform.

The samples were ground in a glass media mill Eiger mill model Mini Motormill 100, loaded with 85 ml of 1.2 mm diameter glass beads. The slurry was added to the feed funnel, and then was ground for 2 minutes at 20-30° C. at 2,000 r.p.m. by recirculating through the mill. The sample was collected through the discharge port after grinding, the collected sample was then weighed and the required amount of low-density particles added with a propeller agitator.

The viscosity of the formulations was tested as follows. A 2 ml sample was placed in the cup of a Brookfield DVIII LVCP cone/plate viscometer. The viscosity was measured with a CP-41 cone as follows. The sample was pre-sheared for 30 seconds at 60 r.p.m., allowed to rest for 30 seconds, the speed was set to 6 r.p.m., and then the viscosity was measured after 4 minutes.

### Example 1

A study was done to demonstrate the effectiveness of hollow glass spheres for reducing phase separation in a tebuconazole flowable seed treatment containing 6 g/Liter of tebuconazole. The control samples were made with the conventional filler, and the examples were made with hollow glass spheres. The composition of each of the test and control samples is shown in Table 1.

Each of the flowables shown in Table 1 were stored at room temperature (20-25° C.) for 6 months. Samples were evaluated for phase separation after storage for comparison. The results are as shown in Table 2. The controls made with conventional fillers had 22-44% bleed layer at high and low viscosities, respectively, whereas the examples had 0-6% bleed layer. Two different grades of hollow glass spheres were used with similar results. Samples were designed with different calculated differences in density (Δd) between the dispersed and continuous phases. All samples with the Scotchlite had a significantly lower Δd, and a significantly lower bleed layer. Viscosity was reasonably constant on storage.

### Example 2

A study was done to demonstrate the effect of the amount of hollow glass spheres on reducing phase separation in a tebuconazole/thiram flowable seed treatment containing 6.7 g/Liter of tebuconazole and 222 g/L thiram. The control samples were made without low-density filler, and the test examples were made with hollow glass spheres. The composition of each of the test and control samples is shown in Table 3.

Each of the flowables shown in Table 3 were stored at an elevated temperature (50° C.) for 1 month. Samples were evaluated for phase separation after storage for comparison. The results are as shown in Table 4. The control made without low-density particulates had at least twice as much bleed as samples that contained such particles. Also, the bleed layer of the samples were least when Δd was near or less than zero. Samples had similar viscosities, which was stable on storage, so it can be concluded that differences in bleed layers was due to the low-density particles rather than viscosity differences. More differentiation between samples is expected on longer-term storage. This example also demonstrates the effectiveness of hollow glass microspheres for inhibiting phase separation in more concentrated flowables.

### Example 3

A study was done to demonstrate the effectiveness of micronized polyethylene (Acumist B6) for reducing phase separation in a tebuconazole flowable seed treatment containing 6 g/Liter of tebuconazole. In the case of the micronized polyethylene, the low density particulate is added to the formulation prior to grinding. The control samples were made with the conventional filler, and the examples were made with polyethylene. Surfactants were changed as necessary to form a stable dispersion. The composition of each of the test and control samples is shown in Table 5.

Each of the flowables shown in Table 5 were stored at room temperature (20-25° C.) for 3 months. Samples were evaluated for phase separation after storage for comparison. The results are as shown in Table 6. The controls made with conventional fillers had 12-30% bleed layer at high and low viscosities, respectively, whereas the example had only trace (<1%) bleed layer. The polyethylene-containing example was designed to have a small difference in density (Δd ) between the dispersed and continuous phases, at −0.02 g/ml, compared to about +0.6 g/ml for the controls.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

TABLE 1

| | Control | Control | Example | Example | Example |
|---|---|---|---|---|---|
| Ingredient | 1A | 1B | 1A | 1B | 1C |
| Soft water | 44.68 | 44.65 | 46.95 | 46.96 | 46.96 |
| Ethylene Glycol | 20.14 | 20.12 | 21.10 | 21.10 | 21.10 |
| Antifoam A | 0.03 | 0.04 | 0.03 | 0.03 | 0.03 |
| Triton X100 | 1.40 | 1.40 | 1.40 | 1.40 | 1.40 |
| Pigment Red 57:1 | 2.42 | 2.48 | 2.42 | 2.42 | 2.42 |
| 10% HCl | 1.20 | 1.21 | 1.21 | 1.21 | 1.21 |
| 10% Sodium Hydroxide | 1.35 | 1.33 | 1.33 | 1.33 | 1.33 |
| Sodium lignosulfonate | 1.20 | 1.20 | 1.20 | 1.20 | 1.20 |
| Stepwet DF-90 | 0.50 | 0.50 | 0.50 | 0.50 | 0.50 |
| Petro Morwet D-425 | 0.70 | 0.70 | 0.70 | 0.70 | 0.70 |
| Mineral oil | 8.00 | 8.00 | 8.00 | 8.00 | 8.00 |
| Calcium Carbonate | 10.00 | 10.00 | 10.50 | 9.50 | 9.50 |
| Tebuconazole Tech 95% | 0.54 | 0.53 | 0.60 | 0.60 | 0.60 |
| Standard filler | 7.79 | 7.79 | 0.00 | 0.00 | 0.00 |
| Xanthan Gum | 0.05 | 0.05 | 0.05 | 0.05 | 0.05 |
| Scotchlite S60 | — | — | — | 5.00 | — |
| Scotchlite K46 | — | — | 4.00 | — | 5.00 |

TABLE 2

| | | Viscosity | % | |
|---|---|---|---|---|
| Sample | Δd (g/ml) | (cps) | Bleed | Comment |
| Control 1A | +0.61 | 118 | 22 | High viscosity control |
| | | | | comparison |
| Control 1B | +0.64 | 70 | 44 | Low viscosity control |
| | | | | comparison |
| Example 1A | −0.02 | 104 | Trace | Lower density Scotchlite; |
| | | | | slight excess Scotchlite |
| Example 1B | −0.01 | 73 | 6 | Higher density Scotchlite; |
| | | | | Δd close to zero |
| Example 1C | −0.10 | 100 | 0 | Low density Scotchlite; |
| | | | | 25% excess Scothlite |

TABLE 3

| | Control | Example | Example | Example | Example |
|---|---|---|---|---|---|
| Ingredient | 2 | 2A | 2B | 2C | 2D |
| Soft water | 40.79 | 36.58 | 37.45 | 38.70 | 39.55 |
| Ethylene Glycol | 22.49 | 20.21 | 20.69 | 21.35 | 21.81 |
| Antifoam A | 0.02 | 0.02 | 0.02 | 0.02 | 0.02 |
| Pluraflo E5B | 3.00 | 3.00 | 3.00 | 3.00 | 3.00 |
| Sodium Lignosulfonate | 1.50 | 1.50 | 1.50 | 1.50 | 1.50 |
| Tebuconazole Tech 95% | 0.63 | 0.67 | 0.67 | 0.65 | 0.64 |
| Thiram Tech 98% | 20.28 | 21.77 | 21.67 | 21.03 | 20.73 |
| Pigment Red 48:2 | 2.40 | 2.40 | 2.40 | 2.40 | 2.40 |
| Fumed Silica | 0.05 | 0.05 | 0.05 | 0.05 | 0.05 |
| Mineral Oil | 8.00 | 8.00 | 8.00 | 8.00 | 8.00 |
| Attapulgite clay | 0.75 | 0.75 | 0.75 | 0.75 | 0.75 |
| Xanthan Gum | 0.09 | 0.05 | 0.05 | 0.05 | 0.05 |
| Scotchlite K46 | — | 5.00 | 3.75 | 2.50 | 1.50 |

TABLE 4

| | | Viscosity | % | |
|---|---|---|---|---|
| Sample | Δd (g/ml) | (cps) | Bleed | Comment |
| Control 2 | +0.17 | 103 | 8 | Most bleed layer without |
| | | | | low-density particulates. |
| Example 2A | −0.07 | 120 | 0 | |
| Example 2B | −0.02 | 120 | 0 | |
| Example 2C | +0.03 | 113 | Trace | |
| Example 2D | +0.08 | 110 | 4 | Adding only 40% of |
| | | | | required Scotchlite gives |
| | | | | significantly less bleed |
| | | | | layer reduction |

TABLE 5

| | Control | Control | Example |
|---|---|---|---|
| Ingredient | 3A | 3B | 3C |
| Soft water | 44.68 | 44.65 | 45.62 |
| Ethylene Glycol | 20.14 | 20.12 | 20.54 |
| Antifoam A | 0.03 | 0.04 | 0.03 |
| Triton X100 | 1.40 | 1.40 | 2.00 |
| Pigment Red 57:1 | 2.42 | 2.48 | 2.42 |
| 10% HCl | 1.20 | 1.21 | 1.21 |
| 10% Sodium Hydroxide | 1.35 | 1.33 | 1.33 |
| Sodium lignosulfonate | 1.20 | 1.20 | 1.20 |
| Stepwet DF-90 | 0.50 | 0.50 | 0.50 |
| Petro Morwet D-425 | 0.70 | 0.70 | — |
| Span 80 | — | — | 2.00 |
| Tween 80 | — | — | 2.00 |
| Mineral oil | 8.00 | 8.00 | 12.00 |
| Calcium Carbonate | 10.00 | 10.00 | 2.50 |
| Tebuconazole Tech 95% | 0.54 | 0.53 | 0.61 |
| Standard filler | 7.79 | 7.79 | — |
| Xanthan Gum | 0.05 | 0.05 | 0.04 |
| Acumist B6 | — | — | 6.00 |

TABLE 6

| | | Viscosity | % | |
|---|---|---|---|---|
| Sample | Δd (g/ml) | (cps) | Bleed | Comment |
| Control 3A | +0.61 | 118 | 12 | High viscosity control |
| | | | | comparison |
| Control 3B | +0.64 | 70 | 30 | Low viscosity control |
| | | | | comparison |
| Example 3A | −0.02 | 100 | Trace | Acumist B6 polyethylene |
| | | | | used as filler |

We claim:

1. A pesticidal chemical flowable composition comprising dispersed ingredients, said dispersed ingredients comprising one or more active ingredients, dispersed in a continuous phase, and an amount of low-density particles sufficient to substantially reduce the difference between the density of the continuous phase and the average density of the dispersed ingredients, inclusive of the low-density particles.

2. The composition according to claim 1, wherein the amount of low-density particles is in the range of about 0.5% to about 25% by weight (wt/wt).

3. The composition according to claim 1, wherein the low-density particles are selected from the group consisting of hollow glass microspheres, hollow ceramic microspheres, perlite, polyethylene and oxidized polyethylene microspheres.

4. The composition according to claim 3, wherein the low-density particles are hollow borosilicate glass microspheres.

5. The composition according to claim 3, wherein the low-density particles are micronized polyethylene.

6. The composition according to claim 1, further comprising one or more wetting agents, dispersants and/or emulsifiers; one or more thickeners; one or more antifreeze compounds; and water.

7. The composition according to claim 6, further comprising ingredients selected from the group consisting of defoamers, preservatives or biocides, dyes or pigments, oil, pH adjusters, stickers and polymers.

8. The pesticidal chemical flowable composition according to claim 1, comprising:
about 0.02% to about 50% of one or more active ingredients,
about 0.5% to about 25% of low-density particles,
about 0.1% to about 5% of one or more dispersants, wetting agents and/or emulsifiers,
about 0.02% to about 3% of one or more thickeners,
about 1% to about 35% of one or more antifreeze compounds,
about 20-80% of water, and;
optionally, one or more ingredients selected from the group consisting of defoamers, antimicrobial agent(s), dyes, pigments, oils, polymers, fillers and other additives commonly used in pesticidal formulations;
wherein the amount of low-density particles is sufficient to substantially reduce the difference between the density of the continuous phase and the average density of dispersed ingredients, inclusive of the low-density particles.

9. The pesticidal chemical flowable composition according to claim 1, wherein the dispersed ingredients comprise one or more active ingredients and fine particles dispersed in a continuous phase, wherein the fine particles are present in an amount sufficient to provide a ratio of fine particles to low-density particles in the range of about 0.1 to about 8.0, preferably about 0.2 to about 6.

10. The composition according to claim 7, wherein the fine particles are selected from the group consisting of calcium carbonate, clays, titanium dioxide, silica, talc, silicates and pigments.

11. The pesticidal chemical flowable composition according to claim 9 comprising:
about 0.02% to about 50% of one or more active ingredients,
about 0.5% to about 25% of low-density particles,
about 0.2% to about 20% of one or more fine particulate materials,
about 0.1% to about 7% of one or more dispersants, wetting agents and/or emulsifiers.
about 0.02% to about 3% of one or more thickeners,
about 1% to about 35% of one or more antifreeze compounds,
about 20-80% of water, and
optionally, one or more ingredients selected from the group consisting of defoamers, antimicrobial agent(s), dyes, pigments, fillers, oils, polymers and other common additives used in pesticidal formulations;
wherein the amount of low-density particles is sufficient to substantially reduce the difference between the density of the continuous phase and the average density of the dispersed ingredients, inclusive of the low-density particles.

12. A use of low-density particles to inhibit phase separation in pesticidal chemical flowables.

13. A method of inhibiting phase separation in pesticidal chemical flowable compositions comprising adding low-density particles to the composition in amounts sufficient to substantially reduce the difference between the density of the continuous phase and the average density of the dispersed ingredients, inclusive of the low-density particles.

14. The method according to claim 13, further comprising adding fine particles to the composition in amounts sufficient to provide a ratio of fine particles to low-density particles in the range of about 0.1 to about 8.0, preferably 0.2 to about 6.0.
